(19) United States
(12) Patent Application Publication
(10) Pub. No.: US 2019/0121860 A1
(43) Pub. Date: Apr. 25, 2019

(54) Conference And Call Center Speech To Text Machine Translation Engine

(71) Applicant: AK Innovations, LLC, a Texas corporation, Plano, TX (US)

(72) Inventors: Azam Ali Mirza, Plano, TX (US); Claudia Mirza, Plano, TX (US); David Rhodes, Tempe, AZ (US)

(73) Assignee: AK Innovations, LLC, a Texas corporation, Plano, TX (US)

(21) Appl. No.: 16/165,857

(22) Filed: Oct. 19, 2018

Related U.S. Application Data
(60) Provisional application No. 62/574,910, filed on Oct. 20, 2017.

(51) Int. Cl. G06F 17/28; G10L 15/22; G10L 15/26

(52) U.S. Cl. CPC G06F 17/289; G10L 15/265; G10L 15/22

(57) ABSTRACT

A system for utilizing conventional speech interpretation and translation sessions to deliver multilingual functionality of telephone and video conferencing systems, and to create a more robust machine translation memory is disclosed.

### FIELD OF THE INVENTION

The present invention relates to a system for utilizing conventional telephone and video conferencing technologies, in conjunction with speech interpretation sessions, and document translation technologies, to create more robust machine translation memories and a multi-group, multilingual desktop sharing and content delivery conferencing platform, which may support real-time text translation, telephonic and video interpretation, and translated, group-specific presentation content. This technology may be particularly beneficial for rare languages, and languages of lesser diffusion, which typically are not frequently seen in translation services.

### BACKGROUND

As used herein, the term linguistic services should be understood to include interpretations and/or translations between/among two or more spoken languages, between/among two or more written languages, or between/among two or more entities having differing education/knowledge levels or skill-sets (i.e., between a lay person and a professional, such as a healthcare professional, a lawyer, an accountant, an engineer, or the like).

Translation, as used herein, should be understood to include conversion of text written in a source language into a linguistically and culturally equivalent text written in a target language.

Interpretation, as used herein, should be understood to include conversion of a spoken source language into a linguistically and culturally equivalent spoken target language.

Transcription, as used herein, should be understood to include conversion of a spoken source language into a text written in the same source language.

Machine translation, as used herein, should be understood to include use of common industry-specific software to translate text from a first, source language into text in a second, target language. Machine translation typically utilizes translation memories, in the form of a computer accessed database, to contextually substitute words, segments, phrases, and the like in a first language into corresponding words and phrases in a second language.

Translation memories, as used herein, should be understood to include collections of word and phrase tables in source languages and corresponding linguistic and culturally equivalent word and phrase tables in target languages. Use of translation memories result in improved accuracy of machine translations which use them. Quality and accuracy of machine translations are generally dependent upon the quality of the translation memory.

Machine transcription, as used herein, should be understood to include use of software to transcribe voice in a first language into text in the same language. As is known, machine transcription typically utilizes transcription memory, in the form of a computer accessed transcription database. Resulting accuracy of such machine transcription is also generally dependent, among other factors, upon the quality of audio signal, and the transcription memory. For common languages, the quality of the transcription memory may be relatively acceptable for certain purposes. However for other purposes, the quality may not be acceptable. And for relatively uncommon languages, the quality of the transcription memory may be relatively bad.

Conferencing, as used herein, should be understood to include commercial or proprietary applications that permit users to connect from remote locations and view content shared by a presenter. Conferences may be audio, video, or a mix of both.

Content delivery, as used herein, should be understood to include a method of sharing and/or showing information on a presenter's computer, with or to a group of conference participants. It may also refer to sending files or documents.

Presenter, as used herein, should be understood to include an individual, a prerecorded presentation, or other content, that is displayed on a computer screen, or streamed and viewed on a computer and that may be shared and made visible, via the conferencing platform, to attendees.

Presentation content, as used herein, should be understood to include the information that originates from a presenter, via a shared desktop, and is shared with attendees. Such content may be in written, video, or audio form. This would be different than Presentation dialogue.

Presentation dialogue, as used herein, should be understood to include the planned and impromptu oral discussions and conversations that may take place during a presentation.

Machine interpretation, as used herein, should be understood to include use of conventional and proprietary industry text-to-voice and voice-to-text software to create voice analogs, which access text translation memories and convert them to machine voice.

### SUMMARY

In accordance with the present invention, a system is provided to utilize conventional interpretation sessions to create more robust machine translation memories.

Other features and advantages of the present invention should become apparent from the following description of the preferred embodiments, taken in conjunction with the accompanying drawings, which illustrate, by way of example, principles of the invention.

### DESCRIPTION OF THE FIGURES

For a more complete understanding of the disclosure, reference should be made to the following detailed description and accompanying drawings, wherein:

FIG. 1 is a block diagram flow chart illustrating one embodiment of a system in accordance with the present invention;

FIGS. 2A, 2B and 2C sequentially form an infographic flow chart further illustrating the system of FIG. 1; and

FIG. 3A. 3B, and 3C illustrate a conference wherein attendees with differing language requirements may participate using the present system

### DESCRIPTION

While this invention is susceptible of embodiment in many different forms, there will be described herein in detail, specific embodiments thereof with the understanding that the present disclosure is to be considered an exemplification of the principles of the invention and is not intended to limit the invention to the specific embodiment illustrated.

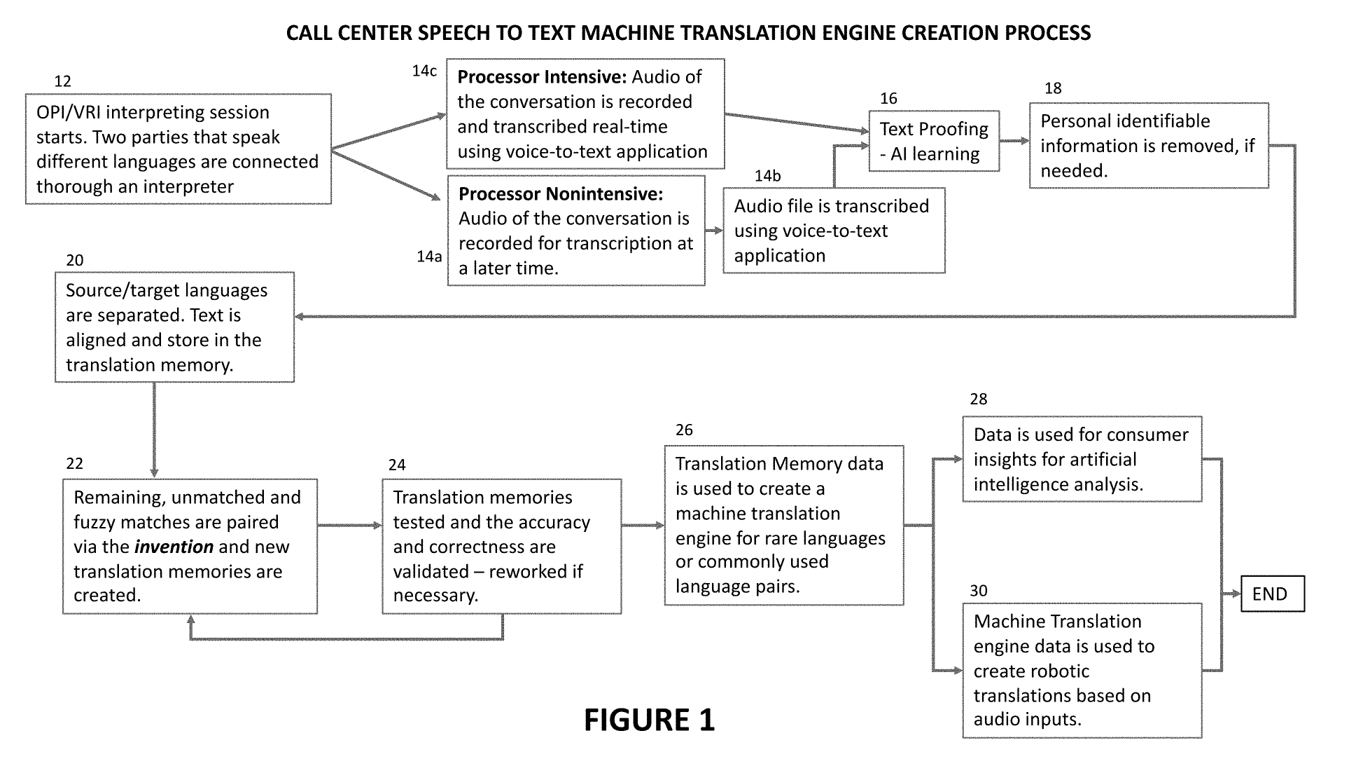

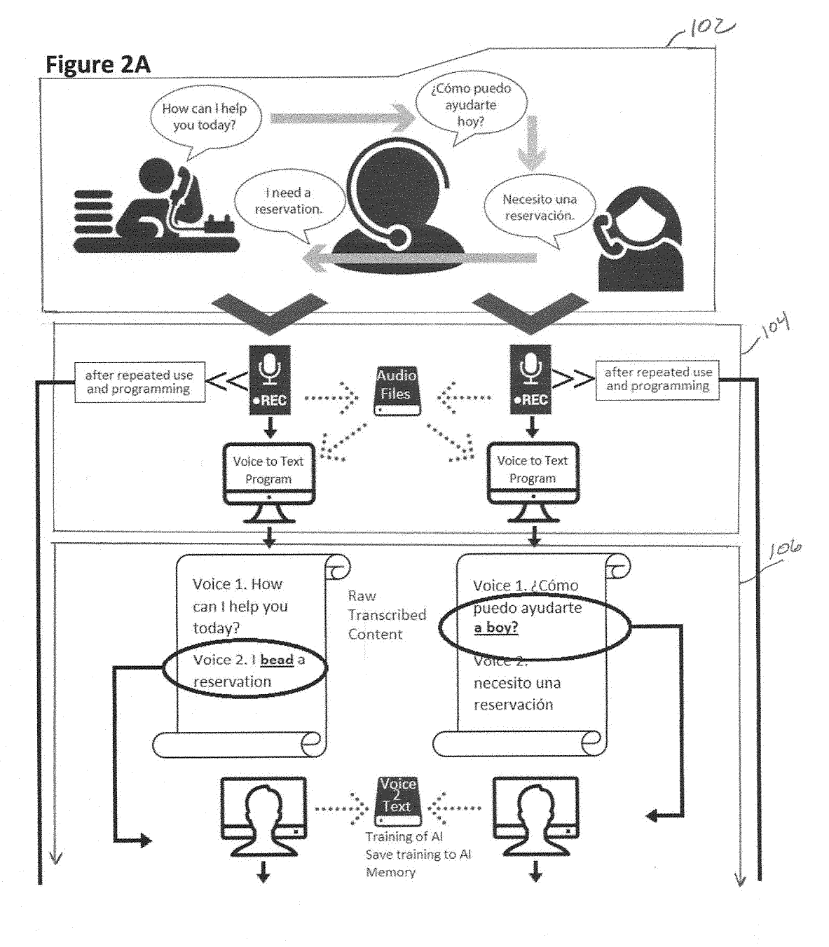

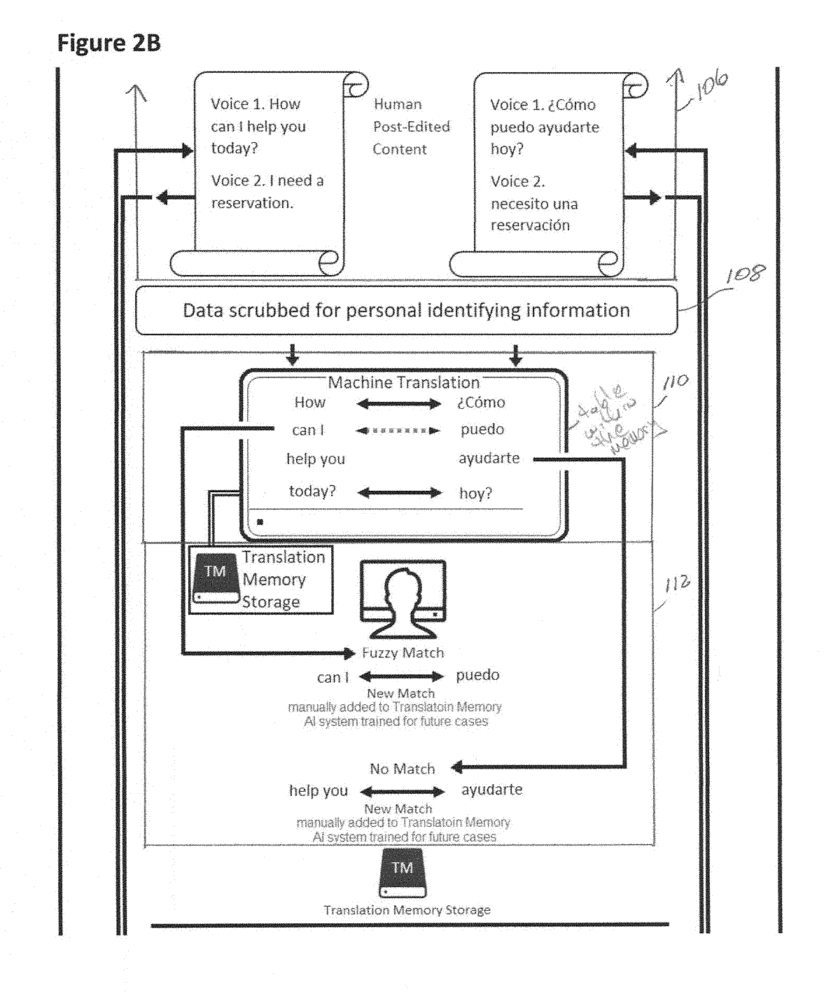

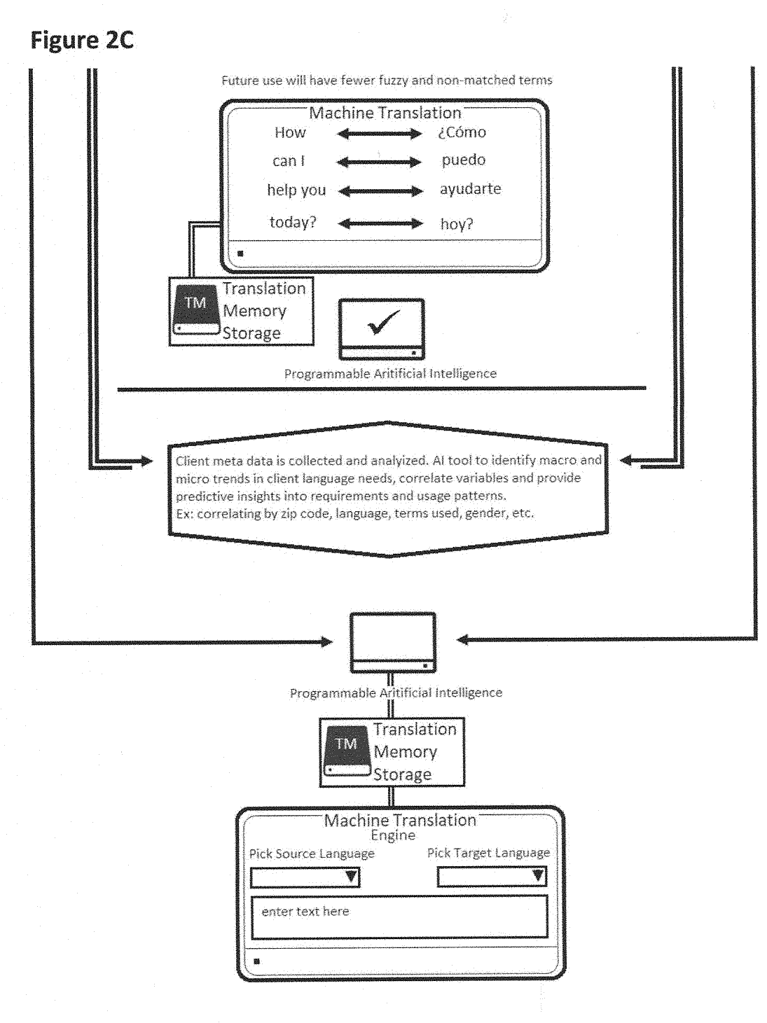

The present system, generally will be described in conjunction with FIGS. 1, 2A-C, and 3A-C.

Referring in particular to FIGS. 1 and 2, in a first step 12, two parties may converse via an interpreter. The interpretation session may be over-phone interpretation (OPI), video remote interpretation (VRI), conference interpretation, or the like.

In the example illustrated in FIG. 2, a first party may speak in a first language, such as English and a second party may speak in a second language, such as Spanish. An intermediary interpreter may interpret the conversation (i.e., convert spoken words of the first party, in the first language, to the corresponding spoken words for the second party in the second language, and vice versa) for the first and second parties. See also FIG. 2, box 102.

Conventionally the interpretive services of the interpreter would be complete upon completion of the conversation. However, as discussed below, in accordance with one aspect of the present invention, the interpreted conversation, in conjunction with one or more other interpretation sessions, may be recorded, and the recording be subsequently utilized to create a more robust machine translation database. This results a one-to-one language pair of source/target language, which has already gone through a human interpretation, which is generally the best possible type of translation.

In a step 14a, audio of the parties' conversation, including that of the interpreter, may be recorded, for transcription, in step 14b, at a later time. Audio-to-text transcription software, such as IBM's Watson, Dragon's Naturally Speaking, Microsoft's Cortana, or any other commercially available software, may be utilized to perform this step. However it is to be understood such audio-to-text transcription software is only as good as its underlying transcription memory. If sufficient computer processor capability is available, steps 14a and 14b may be combined, as step 14c, such that the audio of the conversation may be transcribed in real-time. See also FIG. 2, box 104.

In a step 16, utilizing the recording of the conversation, the transcribed text of the conversation may be proofread by a human to correct any errors, and the transcription memory may be corrected/updated accordingly, the result of which is a more accurate transcription memory for a more accurate transcription on future projects. At this point one may have a transcription of spoken English to English text and, separately, a transcription of spoken Spanish to Spanish text. See also FIG. 2, box 106.

In a step 18, all personal identifiable information, or other confidential information, may be deleted from the text. See also FIG. 2, box 108.

In a step 20, source text (i.e., the text of the spoken input to the interpreter) and corresponding target text (i.e., the text of the interpreted spoken output from the interpreter) may be separated and aligned and saved in translation memory. These new translation memories may be used to resolve uncertain translations, commonly referred to as “fuzzy” matches (where the translation memory includes a possible/not-certain match between the source word or phrase and the corresponding target word or phrase). Similarly, these new translation memories may also be used to resolve non-matching words or phrases (where the translation memory does not include any possible match between the source and the target text). See also FIG. 2, box 110, which includes a box titled Machine Translation illustrating a machine translation memory table of corresponding words, phrases, etc.

In the event of a fuzzy match, a human may correct the error, if any, and the corresponding match may be updated in the translation memory. In the event of a non-match, a human may correct the error, if any, and the corresponding match may be updated in the translation memory. See also FIG. 2, box 112.

In a step 24, the translation memory may be tested by a human, and the accuracy and correctness may be validated by a human, and manually corrected or added to the translation memory for future cases.

Over time, after additional sessions, as the content of the translation memory increases, there may be fewer fuzzy and non-matched terms. At a certain point, the translation memory may be sufficiently accurate to permit one to proceed directly to machine translation, with little, or no, human input.

In a step 26, translation memory data may be used to create a machine translation engine for rare languages or commonly used language pairs.

In a step 28, client metadata may be collected and analyzed. A commercially available artificial intelligence tool may be used to identify macro and micro trends in client language needs, correlate variables and provide predictive insights into requirements and usage patterns. For example, one may correlate by zip code, language, topic, method of connection, terms used, gender, etc.

In a step 30, machine translation engine data may be used to create robotic translations based on audio inputs.

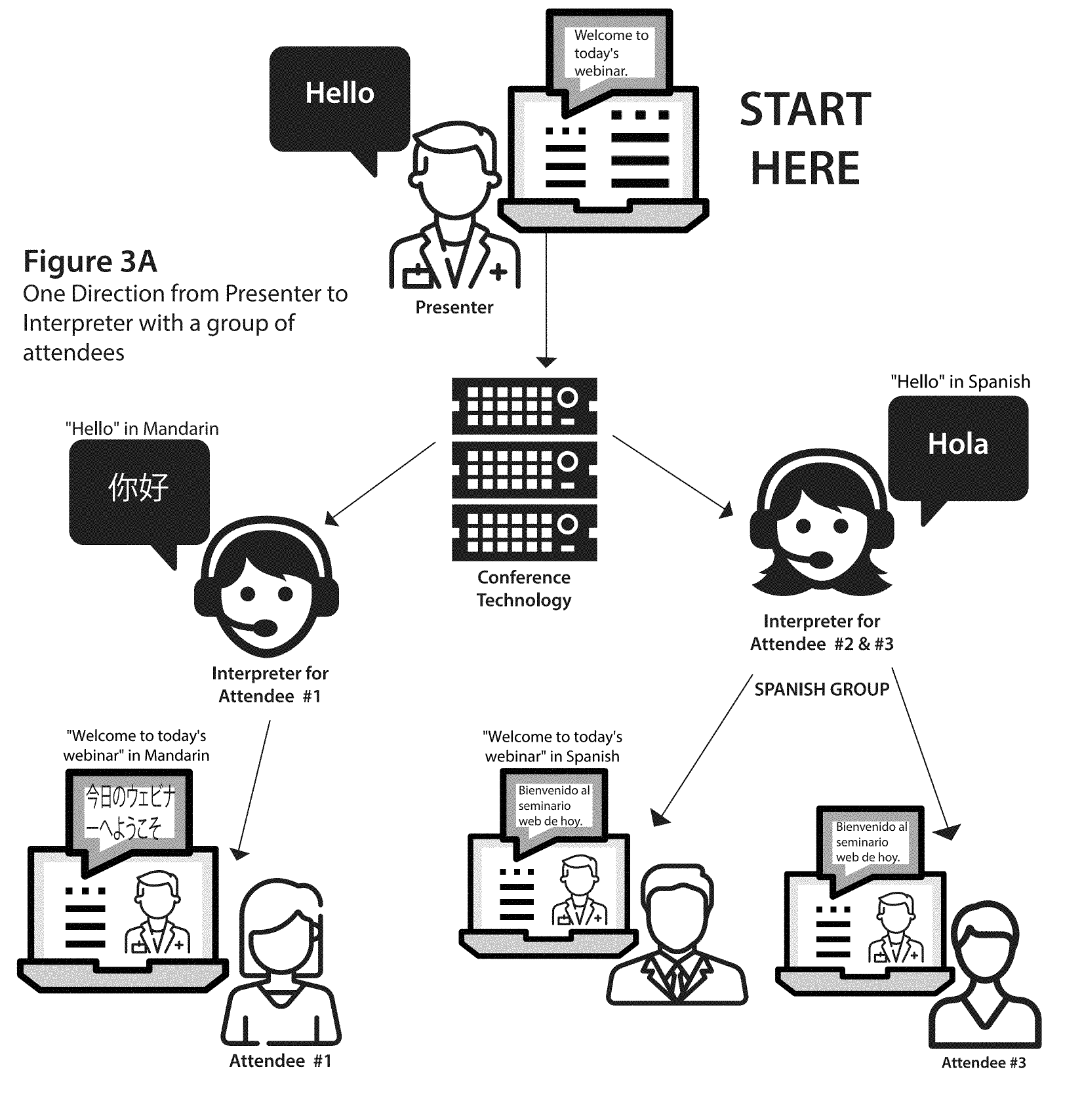

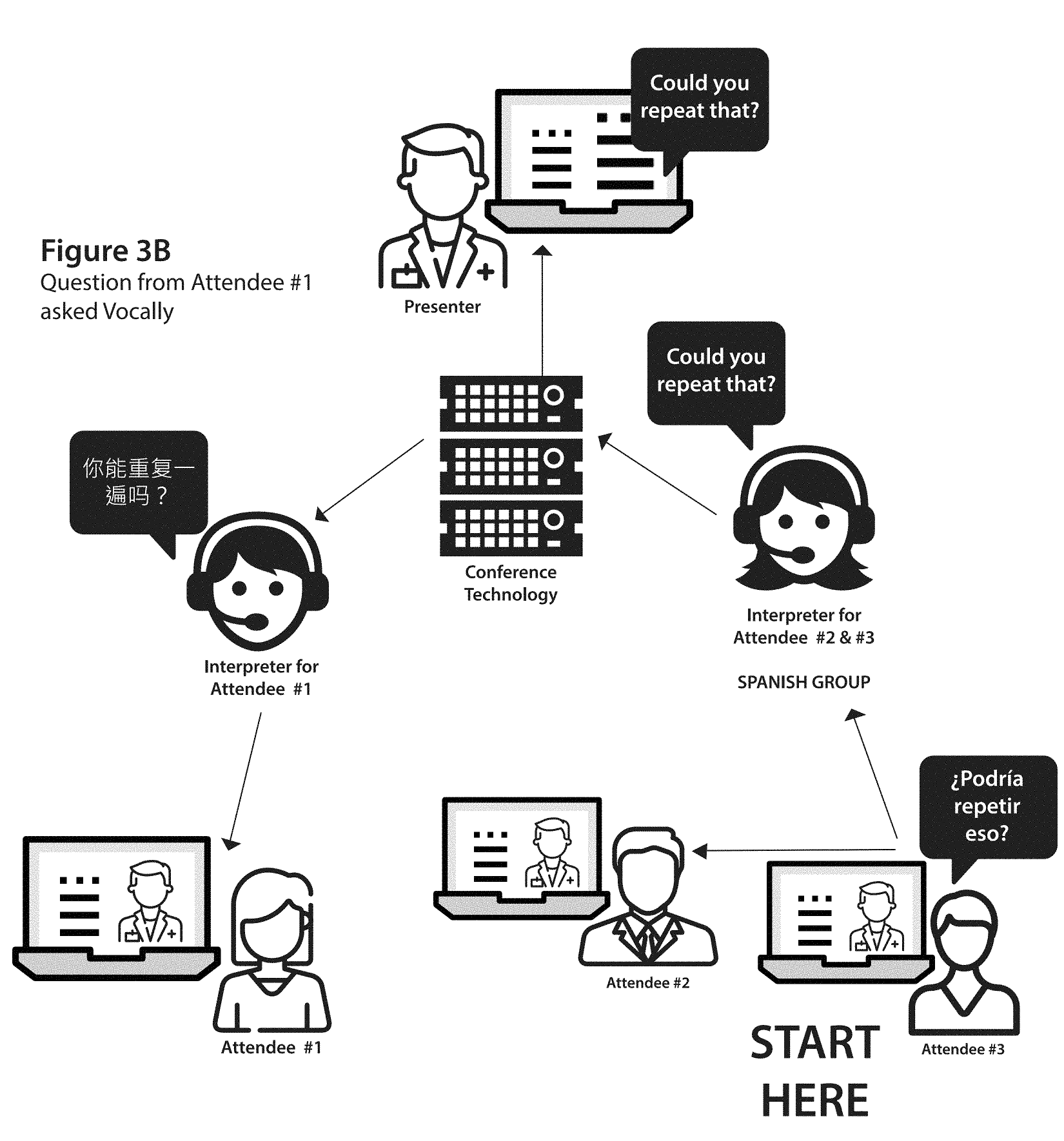

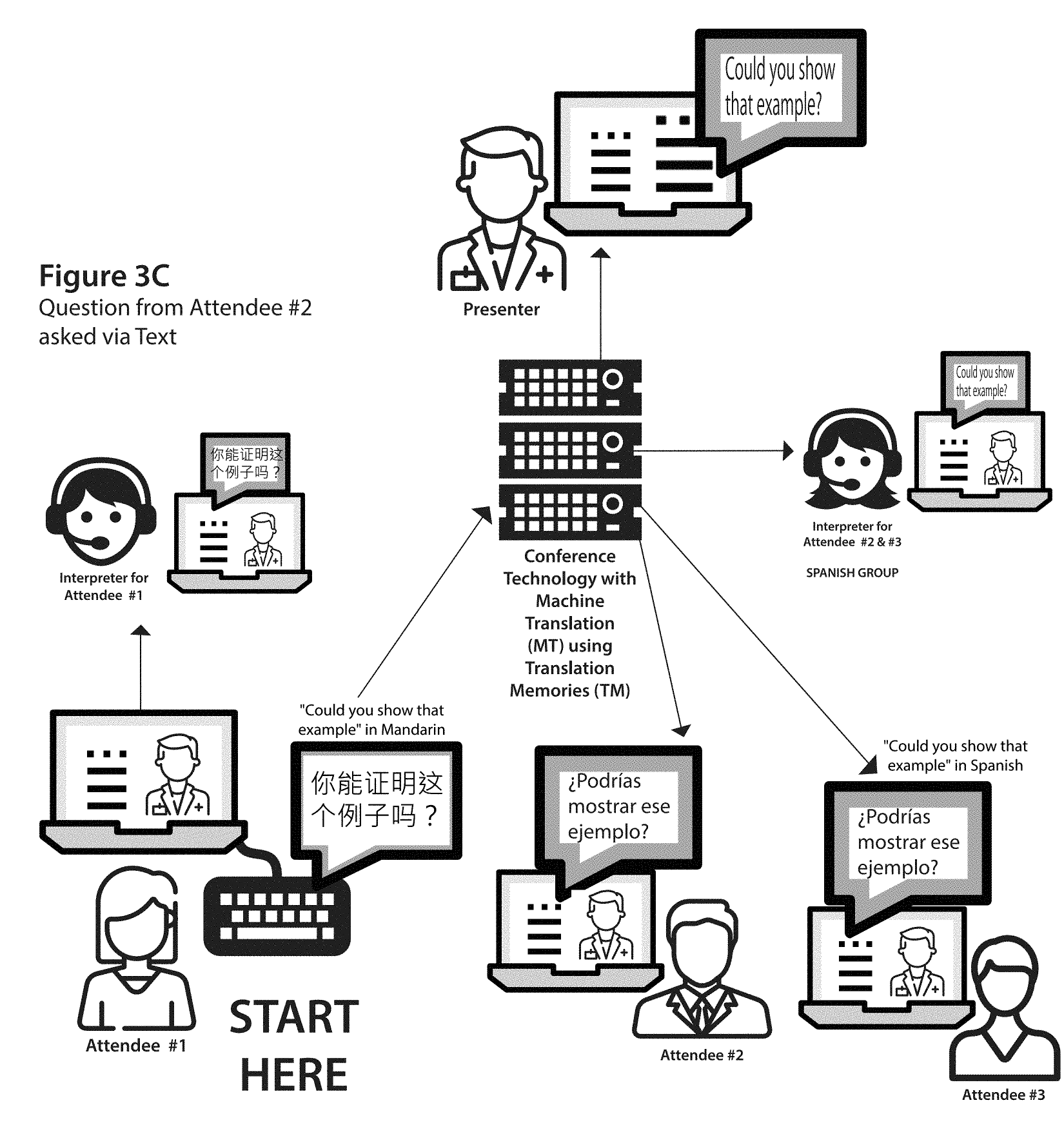

The present system may be scalable. In an example illustrated in FIGS. 3A-3C, a presenter may speak in English and one or more other parties may be non-English speakers. Intermediary interpreters may interpret to a group of attendees (FIG. 3A). The interpreters also interpret comments and questions intended for the presenter (FIG. 3B). Interpreters can hear any statements, made by other interpreters, that are directed toward the presenter, and interpret them to the attendees within their group.

As illustrated in FIGS. 2A-2C, translation memories may be created from interpreted sessions. Similar translation memories may result from interpreted sessions illustrated in FIGS. 3A-3C. These translation memories may be used in workflows illustrated in FIGS. 3A-3C to improve the accuracy of text translations of presenter content, and messages sent over the conference platform.

As illustrated in FIG. 3A, the presenter may share a presentation during the conference. The content of this presentation may be translated prior to the conference, or machine translated, in real-time, at the time of the conference.

The presenter role may be assigned and transferred to an attendee, by the presenter. As a result, the presentation content would change to the information on the screen of the new presenter. This content could be translated, in real-time, as indicated above.

In the example illustrated in FIG. 3A, the presentation content may be shown to each of the attendee groups in the language of that group. Such content may be translated prior to a conference, or rendered real-time into the target language of the attendee group.

In example illustrated in FIG. 3C, conference attendees may type comments and questions and send the comments and/or questions as text messages to the presenter. Such text messages may be translated, using the present system, and visible to all attendees in their native language.

Once the conversation or conference is completed, typically this would be the end of the conversation between/among the parties, ending any further interaction between the parties. However, in accordance with the present invention, the spoken words of each of the parties, and the corresponding spoken interpretation by the interpreter, may be used to create, or further expand, the translation memory for the subject languages, as discussed above with respect to FIGS. 1 and 2.

In another iteration of the present invention, two users, that speak different languages, may connect and use machine interpretation, leveraging a translation memory created by the present invention, to communicate over a phone, mobile app, or other communication device. It should be understood that the content of such an encounter may be topical, and as such common and frequently used word and phrase pairs may be readily known and accessible to a translation memory. In such cases, one user, a foreign language speaker staying in a hotel for example, may ask a question to the clerk who will hear the question as it is rendered, via machine interpretation, voiced in an earpiece, speaker, or other communication device, overlaid on the original, foreign language question. Conversely, the clerk may offer a common and frequently used response, which may be readily available in the translation memory, in order to provide a response to such questions. The same example may be applied to a call center operator, who may be connected to a foreign language speaker. The operator may hear questions from foreign language speakers after they have passed through the machine interpretation process. Responses from the caller may also be machine interpreted in the same manner.

It is to be understood that this disclosure, and examples herein, is not intended tolimit the invention to any particular form described, but to the contrary, the invention is intended to include all modifications, alternatives and equivalents falling within the spirit and scope of the invention as defined by the appended claim.

We claim:

1. A method for utilizing a plurality of speech interpretation sessions to iteratively create a more robust machine translation memory, each of the speech interpretation sessions comprising an interpreter interpreting speech from a first party, speaking in a first language, to speech in a second language, the machine translation memory for translating text between text in the first language and text in the second language, the method comprising:
for each of the speech interpretation sessions, machine transcribing the speech between the first party and the second party to corresponding text in the corresponding language;
proofreading the machine transcribed text for each of the speech interpretation sessions;
correcting any determined errors in the corresponding machine transcribed text;
aligning the machine transcribed text in the first language with corresponding machine transcribed text in the second language;
proofreading the aligned machine transcribed text;
correcting any errors in the aligned machine transcribed text; and
saving the corrected aligned machine transcribed text in the machine translation memory.

2. The method of claim 1, wherein the interpretation sessions are recorded, and the human utilizes the recordings when proofreading the machine transcribed text.

3. The method of claim 1, wherein the speech interpretation session includes a second interpreter interpreting speech between the first party and a third party.

4. The method of claim 1 including removing any personal identifying information from the machine transcribed text.
